(19) United States
(12) Patent Application Publication
(10) Pub. No.: US 2011/0016329 A1
(43) Pub. Date: Jan. 20, 2011

(54) INTEGRATED CIRCUIT CARD HAVING A MODIFIABLE OPERATING PROGRAM AND CORRESPONDING METHOD OF MODIFICATION

(76) Inventors: Cyrille Pepin, Andresy (FR); Guillaume Roudiere, Boulogne Billancourt (FR)

Correspondence Address: Muncy, Geissler, Olds & Lowe, PLLC, 4000 Legato Road, Suite 310, FAIRFAX, VA, 22033, US

(21) Appl. No.: 12/922,326

(22) PCT Filed: Mar. 11, 2009
(86) PCT No.: PCT/FR09/00249

§ 371 Date: Sep. 13, 2010

(30) Foreign Application Priority Data
Mar. 13, 2008 (FR) 08 01389

(51) Int. Cl. G06K 19/073; G06F 21/00

(52) U.S. Cl. 713/189; 235/492; 726/22

(57) ABSTRACT

A smart card including a processor unit associated with a ROM and with a programmable ROM. The ROM contains an operating program that can be executed by the processor unit and that includes functional portions, each defining a function of the processor unit. The program includes an entry/exit point for each functional portion and an identifier is associated with each functional portion. The programmable ROM contains at least one substitutable functional portion suitable for substituting one of the functional portions of the ROM and associated with an identifier corresponding to the identifier of the corresponding functional portion of the ROM, and the processor unit is arranged to execute the substitutable functional portion instead of the corresponding substitutable functional portion of the ROM.

The present invention relates to a smart card suitable for use in particular as a data medium, e.g. for constituting means for identifying a carrier of the card, means for accessing premises or equipment, means for payment such as a bank card or a telephone card, . . . .

### BACKGROUND OF THE INVENTION

A smart card generally comprises a body having fastened thereto an integrated circuit that includes a processor that forms a processor unit, a read-only memory (ROM), and a programmable ROM, e.g. of the electrically-erasable programmable read-only memory (EEPROM) type. The processor unit is arranged to execute an operating program that is in contained in the ROM and that comprises functional portions, each defining a function of the processor unit. The data used by the processor unit is generally contained in the programmable ROM. ROMs are less expensive than programmable ROMs, so using a ROM for storing the operating program serves to limit the cost of the smart card. However, the operating program needs to be stored in the ROM at the time the integrated circuit is fabricated and it is no longer modifiable thereafter. Improving the operating program, and more generally, making any modification thereto, therefore requires new integrated circuits to be fabricated.

### OBJECT OF THE INVENTION

An object of the invention is to provide means enabling the operating program to be modified in simple and rapid manner, and in a manner that is optionally applicable to existing cards.

### BRIEF DESCRIPTION OF THE INVENTION

To this end, the invention provides a smart card including a processor unit associated with a ROM and with a programmable ROM, the ROM containing an operating program that can be executed by the processor unit and that includes functional portions, each defining a function of the processor unit. The program includes an entry/exit point for each functional portion, and an identifier is associated with each functional portion. The programmable ROM contains at least one substitutable functional portion suitable for substituting one of the functional portions of the ROM and associated with an identifier corresponding to the identifier of the corresponding functional portion of the ROM. The processor unit is arranged to execute the substitutable functional portion instead of the corresponding functional portion of the ROM.

The entry/exit points of the operating program are thus arranged between each of the functional portions so that the processor unit can short-circuit an original functional portion of the operating program and instead execute a substitutable functional portion stored in the programmable ROM. In addition, the multiplicity of entry/exit points in the operating program makes it possible to limit the sizes of the program pieces that make up the substitutable functional portions stored in the programmable ROM to the sizes of the functional portions that are to be replaced. The amount of programmable ROM that is occupied by the substitutable functional portions is thus relatively small. The substitutable functional portions may be stored in the programmable ROM not only by the manufacturer of the integrated circuit, but also by the issuer of the cards, thereby simplifying management thereof.

Advantageously, the substitutable functional portion is loaded into a start zone of the programmable ROM.

This makes it possible to accelerate searching for substitutable functional portions such that execution of the operating program is not slowed down in harmful manner.

Preferably, the programmable ROM includes an indicator for indicating the presence of a substitutable functional portion.

Thus, the processor unit can quickly detect whether it is necessary to read the programmable read-only memory in order to search for a substitutable functional portion.

Also preferably, the processor unit is programmed to authenticate the substitutable functional portion at least prior to first execution thereof.

A dishonest person might be tempted to use a substitutable functional portion in order to gain access to confidential information contained in the integrated circuit or in order to cause the processor unit to perform operations that are normally not allowed. Authenticating the substitutable functional portion makes it possible to verify that the substitutable functional portion was stored by an authorized person and is therefore, a priori, harmless.

Under such circumstances, and advantageously, a signature is associated with the or each substitutable functional portion and the processor unit is programmed to verify the authenticity of the or each signature, and/or the substitutable functional portion is encrypted and authentication comprises a stage of decrypting and verifying padding bits.

These authentication techniques are reliable and fast.

The invention also provides a method of verifying a program contained in a ROM and executable by a processor unit of an integrated circuit, the program including functional portions, each associated with an identifier and an entry/exit point, and the method comprising the steps of:

storing in the programmable ROM at least one substitutable functional portion suitable for substituting one of the functional portions of the ROM and associated with an identifier corresponding to the identifier of the corresponding functional portion of the ROM; and

on execution of the program by the processor unit, executing the substitutable functional portion instead of the corresponding functional portion.

Other characteristics and advantages of the invention appear on reading the following description of a particular, non-limiting embodiment of the invention.

### BRIEF DESCRIPTION OF THE DRAWING

Reference is made to the accompanying drawing, in which:

FIG. 1 is a block diagram showing a smart card in accordance with the invention;

FIG. 2 is a block diagram of the contents of the read-only memories of the card; and

FIG. 3 is a block diagram of a substitutable functional portion used in the card.

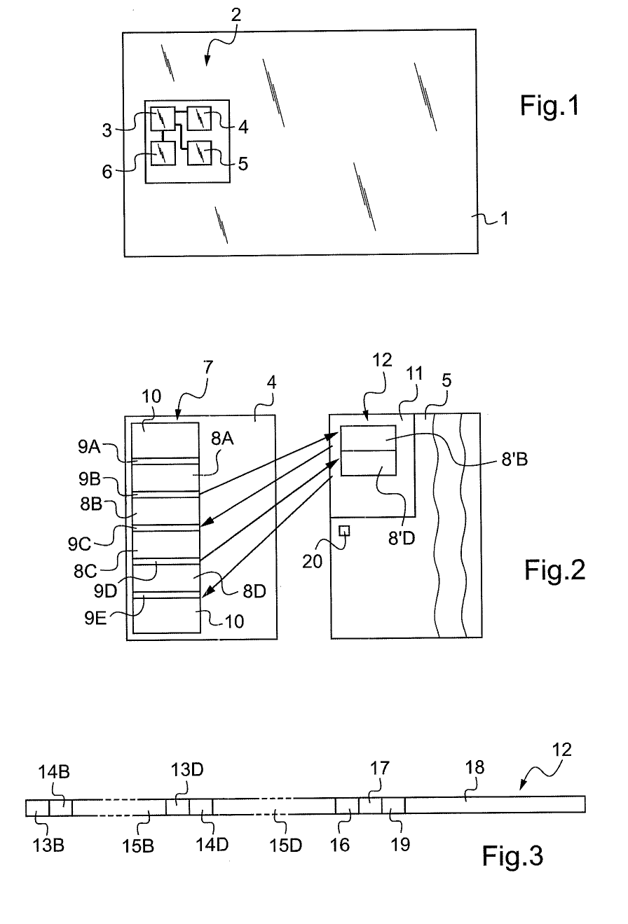

### DETAILED DESCRIPTION OF THE INVENTION

With reference to the figures, the card in accordance with the invention comprises a body 1 having fastened thereto an integrated circuit given overall reference 2 and comprising a processor unit 3, such as a processor, connected to a ROM 4, a programmable ROM 5, of the EEPROM type in this example, and a random access memory (RAM) 6. The physical structure of the card in accordance with the invention is itself known.

The ROM 4 contains an operating program given overall reference 7, having a main module 10 and functional portions 8 (distinguished from one another by indices A, B, C, & D), with entry/exit points 9 of the program being arranged therebetween (and individualized by indices A to E).

Each functional portion 8 is associated with an identifier that is specific thereto.

The term “operating program” is used to designate a program that, on being executed, enables the processor unit 3 to perform processing functions that correspond to each portion of the program making up a functional portion. The operating program may comprise portions providing basic operation of the processor unit (operating system) or application portions. The program may include functional modules that group together a plurality of functional portions.

In known manner, the programmable ROM 5 contains optionally confidential data that is used by the processor unit when executing the operating program. The RAM 6 contains data received from the outside or for issuing to the outside, and also intermediate results of computations performed by the processor unit while executing the operating program.

The programmable ROM 5 possesses a start 11 that contains a data block, given overall reference 12, including substitutable functional portions 8′ (individualized by means of indices B and D) that are for replacing the functional portions 8B and 8D. The block 12 is stored in the form of a repetition of patterns comprising in succession:

the identifier 13B of the substitutable functional portion 8′B;

an indication 14B of the length of the data of the substitutable functional portion 8′B;

the data 15B in question;

an integrity value calculated on the identifier 13B, the indication 14B, and the data 15B (by way of example, the integrity value is the result of a cyclic redundancy check (CRC) type method);

the identifier 13D of the substitutable functional portion 8′D;

an indication 14D of the length of the data of the substitutable functional portion 8′D;

the data 15D in question;

an end identifier 16;

an indication 17 of the length of the end data; and

the data in question incorporating in particular a signature, and optionally an acceleration indicator 19 and an integrity value.

During execution of the operating program, the processor unit 3 verifies the presence in the programmable ROM 5 of an indicator 20 of the presence of substitutable functional portions 8′. Where appropriate, the processor unit 3 verifies, for each functional portion 8, whether there exists a substitutable functional portion 8′, and if one does exist, it executes the substitutable functional portion instead of the corresponding functional portion 8.

The acceleration indicator 19 identifies the functional module in which the functional portion is to be replaced, thereby enabling execution of the program to be accelerated.

Prior to execution of each functional portion, the identifiers of the substitutable functional portions 8′ are scanned and compared with the identifier of the functional portion that the processor unit 3 is preparing to execute.

To execute the substitutable functional portions 8′, e.g. the substitutable functional portion 8′B, the processor unit exits the operating program via the entry/exit point 9B that precedes the corresponding functional portion 8B, and after executing the substitutable functional portion 8′B, returns to the operating program via the entry/exit point 9C that follows the corresponding functional portion 8B.

Prior to executing the first substitutable functional portion 8′B, the processor unit 3 proceeds with an authentication step that consists in verifying the signature of the block 12 of substitutable functional portions 8′. If the signature is authenticated, the substitutable functional portions 8′ are executed normally. Otherwise, the processor unit 3 executes the original operating program 7. In a variant, provision may be made for the processor unit 3 to issue a warning signal when the block 12 of substitutable functional portions 8′ is not authenticated.

In addition, provision is preferably made to verify the integrity of the substitutable functional portions before executing them by using the integrity value 19 as calculated on the identifier 13B, the indication 14B, and the data 15B.

On each new execution of the operating program, the information of the start zone 11 where the block 12 of substitutable functional portions 8′ is stored and its signature are recovered by means of a dedicated command of the processor unit 3. The response to this command may take the following forms:

there is no substitutable functional portion, so the response may be constituted for example by a string of bytes having the value FF;

there is a stored substitutable functional portion that has been validated, the response may then be constituted by the list of the functional portions that are to be replaced and the signature of the signature block; and

there is a substitutable functional portion that has been loaded but not validated, with the response then being constituted, for example, by a string of bytes having the value 00.

In the second circumstance, the signature is verified before executing the first substitutable functional portion 8′.

The loading of the functional portions 8′ in the programmable ROM is described below.

Prior to loading, the operator needs to be authenticated by means of a key.

The block 12 of substitutable functional portions 8′ is communicated in encrypted form to the processor unit 3 for storing in the start zone 11 of the programmable ROM 5. The processor unit 3 then performs a step of validating the block 12 of substitutable functional portions 8′. This validation step is performed by decrypting the block 12 of substitutable functional portions 8′ and by verifying that the padding bits match (bits used during encrypting). Verifying the padding bits enables the card to be sure that it is indeed the intended destination for the block 12. Thereafter, the processor unit 3 verifies the signature and the integrity element in the block 12 of substitutable functional portions 8′. It should be observed that the signature itself may constitute the integrity element. By way of example, the integrity element may be obtained by the CRC method that consists in processing the data block as though it were a string of binary coefficients of a polynomial.

If either of these two verifications fails, loading is interrupted and the block is invalidated, thereby making it unusable. Once the substitutable functional portions 8′ have been stored in the programmable ROM 5, the size of the available memory is calculated and stored. The indicator that substitutable functional portions are present is updated in a determined zone of the programmable ROM 5.

When a substitutable functional portion 8′ becomes useless (e.g. if it is to be executed only a limited number of times), said substitutable functional portion may be deleted, e.g. by reloading a new block 12 of substitutable functional portions 8′ that does not contain the expired substitutable functional portion. It is also possible to erase all of the substitutable functional portions.

Encrypting the block of substitutable functional portions is advantageous in particular when the manufacture and/or upgrading of cards is subcontracted to a supplier who also makes cards for competitors. Different decrypting codes maybe associated with each competitor so as to ensure that none of them can by accident or by evil intent gain access to the blocks of substitutable functional portions of their competitors. More generally, this also prevents third parties from gaining access to the content of a block of substitutable functional portions.

Naturally, the invention is not limited to the embodiment described above, but on the contrary covers any variant using equivalent means to reproduce the essential characteristics set out above.

In particular, the number and the format of the substitutable functional portions may be modified. The architecture of the block of substitutable functional portions may also be modified.

In addition, other types of programmable ROMs may be used instead of an EEPROM, and in particular it is possible to use an erasable programmable memory (EPROM).

What is claimed is:

1. A smart card including a processor unit associated with a ROM and with a programmable ROM, the ROM containing an operating program that can be executed by the processor unit and that includes functional portions, each defining a function of the processor unit, wherein the program includes an entry/exit point for each functional portion, and an identifier is associated with each functional portion, wherein the programmable ROM contains at least one substitutable functional portion suitable for substituting one of the functional portions of the ROM and associated with an identifier corresponding to the identifier of the corresponding functional portion of the ROM, and wherein the processor unit is arranged to execute the substitutable functional portion instead of the corresponding functional portion of the ROM.

2. The smart card according to claim 1, wherein the substitutable functional portion(s) are loaded into a start zone of the programmable ROM.

3. The smart card according to claim 1, wherein the programmable ROM includes an indicator for indicating the presence of a substitutable functional portion.

4. The smart card according to claim 1, wherein the processor unit is programmed to authenticate the substitutable functional portion at least prior to first execution thereof.

5. The smart card according to claim 4, wherein a signature is associated with the or each substitutable functional portion and the processor unit is programmed to verify the authenticity of the or each signature.

6. The smart card according to claim 5, wherein the or each substitutable functional portion is encrypted, and authentication comprises a stage of decrypting and verifying padding bits.

7. A method of verifying a program contained in a ROM and executable by a processor unit of an integrated circuit, the program including functional portions, each associated with an identifier and an entry/exit point, and the method comprising the steps of
storing in the programmable ROM at least one substitutable functional portion suitable for substituting one of the functional portions of the ROM and associated with an identifier corresponding to the identifier of the corresponding functional portion of the ROM; and
on execution of the program by the processor unit, executing the substitutable functional portion instead of the corresponding functional portion.

8. The method according to claim 7 comprising, after the substitutable functional portion has been stored, a step of the processor unit authenticating the substitutable functional portion, and in the event of authentication succeeding, a step of validating the substitutable functional portion, enabling it to be executed subsequently.

9. The method according to claim 7, wherein the substitutable functional portion is stored in encrypted form and the method includes the step of the processor unit decrypting the substitutable functional portion.

10. The method according to claim 7, including the step of erasing a substitutable functional portion after at least one use.
